(19) United States
(12) Patent Application Publication
(10) Pub. No.: US 2025/0382945 A1
(43) Pub. Date: Dec. 18, 2025

(54) AIRFOIL SEPARATION FLUTTER FOR WIND ENERGY HARVESTING OR FLIGHT CONTROL

(71) Applicant: Embry-Riddle Aeronautical University, Inc., Daytona Beach, FL (US)

(72) Inventor: Vladimir Golubev, Ponce Inlet, FL (US)

(21) Appl. No.: 19/229,832

(22) Filed: Jun. 5, 2025

Related U.S. Application Data
(60) Provisional application No. 63/657,060, filed on Jun. 6, 2024.

(51) Int. Cl. F03D 9/00; F03D 1/06

(52) U.S. Cl. CPC F03D 9/00; F03D 1/0641; F05B 2220/709; F05B 2260/601

(57) ABSTRACT

Wind energy harvesting can be performed using an airfoil structure. Such harvesting can include control of airfoil operation, such as to support harvesting energy from oscillations associated with one-degree-of-freedom (1-DOF, e.g., pitching) or two-degree-of-freedom (2-DOF, e.g., pitching and plunging) operation. For example, control of airfoil operation can include sustaining stable oscillation corresponding to limit-cycle oscillation (LCO) in pitch, or both pitch and plunging degrees of freedom. Examples can include use of a synthetic jet actuator (SJA) to modify a flow attachment characteristic associated with the airfoil structure. According to various examples, a modified Glauert airfoil configuration can be used. The approach herein can also be used to achieve aerodynamic control of aircraft, such as unmanned aircraft.

### CLAIM OF PRIORITY

This patent application claims the benefit of priority of Vladimir V. Golubec, U.S. Provisional Patent Application No. 63/657,060, titled “WIND ENERGY HARVESTING USING AIRFOIL SEPARATION FLUTTER,” filed on Jun. 6, 2024 (Attorney Docket No. 4568.021PRV), which is hereby incorporated by reference herein in its entirety.

### STATEMENT REGARDING FEDERALLY SPONSORED RESEARCH OR DEVELOPMENT

This invention was made with government support under 1809790 awarded by the National Science Foundation. The government has certain rights in the invention.

### FIELD OF THE DISCLOSURE

This document pertains generally, but not by way of limitation, to wind energy harvesting, and more particularly, to approaches that can include use of a Glauert airfoil configuration, along with, for example, control of airfoil operation, such as to support harvesting energy from oscillations associated with one-degree-of-freedom (1-DOF) or two-degree-of-freedom (2-DOF) operation. The techniques described herein are also applicable to flight control.

### BACKGROUND

One form of renewable energy is energy derived from wind. Existing wind energy harvesting systems generally rely on rotating turbines and mechanical components that can be costly to maintain and may also have limited operational ranges relative to wind velocity. Such turbine-based systems may struggle to efficiently extract energy at lower wind speeds. Such systems are generally quite large and may not be economically viable for more compact or local wind energy harvesting applications.

### SUMMARY OF THE DISCLOSURE

The present inventor has recognized that other approaches for wind energy harvesting systems are generally unable to operate efficiently at low wind speeds while maintaining robust control over an energy extraction process. Developments in flow control and acroclastic systems have enabled new approaches to wind energy harvesting. Specifically, airfoil structures that can sustain controlled oscillations present an opportunity for energy extraction without requiring complex mechanical components. In an example, use of one or more synthetic jet actuators can effectively modify airflow characteristics and control acroclastic response in an airfoil system. Prior control schemes have focused on suppressing oscillations. By contrast, the present inventor has recognized among other things that a control scheme can be used to enhance or sustain oscillations for energy harvesting purposes, across a wide range of wind speeds, such as below a critical speed or flow velocity corresponding to a critical flutter speed.

In an example, a wind energy harvesting system can use controlled airfoil oscillations (e.g., cyclic oscillation such as corresponding to limit cycle oscillation behavior) to extract energy from airflow. As an illustrative example, a system can include a modified Glauert (MG) airfoil structure with synthetic jet actuators embedded in its upper and lower surfaces. The airfoil can be mounted using an elastic support that enables at least plunging motion, allowing the airfoil to undergo sustained oscillations even at wind speeds below the critical flutter speed. As an example, synthetic jet actuators can be located near a natural flow separation region of an airfoil to control oscillation characteristics. A controller circuit can be used to activate actuators, such as in response to airfoil motion, to maintain a specified oscillation amplitude across a range of wind speeds. The controlled oscillations can be used to drive an energy harvesting device, such as a piezoelectric transducer, to convert the mechanical motion into useful energy.

As an illustration, a modified Glauert (MG) airfoil profile can enable separation-induced flutter at subcritical velocities, allowing energy extraction at lower wind speeds compared to other airfoil configurations. The system can operate in either a single degree-of-freedom mode focusing on plunging motion, or in a two degree-of-freedom mode incorporating both plunging and pitching motions. A controller circuit can implement open-loop or closed-loop strategies to optimize the oscillation characteristics for energy harvesting. Actuators can be used to modify the flow attachment properties of the airfoil to sustain and amplify a desired oscillatory motion. Generally, the approaches described herein can provide robust control over a wide range of operating conditions without requiring or using mechanical control surfaces. Accordingly, the present subject matter can also be used for flight control, such as for unmanned aerial vehicles (UAVs).

For unmanned aircraft applications, the control approach described herein can provide rapid response times such as to mitigate gust effects or improve flight stability. The controller circuit can perform a machine-implemented method, such as including a matrix decomposition technique to handle uncertainties in flow conditions or actuator dynamics, or both. For example, such an approach can operate using minimal knowledge of the actuator dynamic model while still compensating for system uncertainties. Various illustrative examples described herein validate the control approach through simulation and experimental evaluation. The analysis examines both single degree-of-freedom (plunging) and two degree-of-freedom (plunging and pitching) configurations using open-loop and closed-loop control strategies. Use of an MG airfoil configuration enables sustained oscillations at subcritical velocities through natural separation-induced flutter, making it effective for low-speed energy harvesting.

In an example, a wind energy harvesting system can include an airfoil structure defining an upper surface and a lower surface, at least one synthetic jet actuator located in at least one of the upper surface or lower surface, an elastic mounting system supporting the airfoil structure and enabling at least plunging motion of the airfoil structure, and a controller configured to activate the at least one synthetic jet actuator to sustain cyclic oscillation of the airfoil structure in a plunging degree of freedom at flow velocities below a critical flutter speed. For example, a piezoelectric energy conversion structure can be mechanically coupled to the airfoil structure and configured to extract energy from the plunging motion. The airfoil structure can include an airfoil body having an upper surface and a lower surface, the upper surface and the lower surface comprising Glauert airfoil profiles. For example, a modified Glauert airfoil body can be defined as a symmetric airfoil formed by mirroring an upper surface profile of a Glauert airfoil to define a lower surface profile. In an example, a first synthetic jet actuator can be embedded in the upper surface and a second synthetic jet actuator embedded in the lower surface. In an example, the first and second synthetic jet actuators can be configured to actively modify flow attachment characteristics of the airfoil body in response to a controller.

In an example, a technique, such as a machine-implemented method can include exposing a modified Glauert airfoil (or other airfoil structure) to an airflow having a velocity below a critical flutter speed, the modified Glauert airfoil located in an elastic support system enabling at least plunging motion and extracting energy from sustained oscillations of the at least plunging motion. In an example, the technique can include activating at least one synthetic jet actuator embedded in an upper surface or a lower surface of the airfoil to sustain limit cycle oscillations in the plunging motion. For example, the at least one synthetic jet actuator can be located in a range of 67% to 68% chord from a leading edge of the airfoil structure. In an example, the at least one synthetic jet actuator comprises a first synthetic jet actuator embedded in the upper surface and a second synthetic jet actuator embedded in the lower surface. For example, a controller can be configured to activate the first and second synthetic jet actuators respectively in synchronization with a natural plunging frequency of the airfoil structure, such as alternately.

This summary is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally an example comprising a system that can include an airfoil and a controller circuit.

FIG. 2 illustrates generally model variables that can be associated with a two degree of freedom (2-DOF) elastically-mounted airfoil excited by an impinging sharp-edge gust.

FIG. 3 illustrates generally an example comprising a synthetic jet actuator (e.g., a synthetic jet micro-actuator) that can be included or used in association with an airfoil, such as to provide controllability of the airfoil.

FIG. 4A illustrates generally an illustrative example of an airfoil configuration having a symmetrical profile defining an upper surface and a lower surface, along with associated numerical grid used for numerical simulations described herein.

FIG. 4B illustrates generally an illustrative example of an airfoil configuration and synthetic jet actuator port locations.

FIG. 5A, FIG. 5B, and FIG. 5C are illustrative examples comprising contours of simulated Z-axis vorticity for modified Glauert airfoil configurations having no SJA, a non-optimized SJA location, and an optimized SJA location, respectively.

FIG. 6A and FIG. 6B are illustrative examples comprising contours of simulated time-averaged U-velocity contours for modified Glauert airfoil configurations having a non-optimized SJA location, and an optimized SJA location, respectively.

FIG. 7A and FIG. 7B are illustrative examples comprising simulated suppression pitching limit cycle oscillations (LCO) of a modified Glauert airfoil configuration, with suppression achieved by the feedback-loop robust control system with increasing freestream velocities (U=18.25, 28.5 m/s).

FIG. 8 is an illustrative example comprising simulated time histories of pitching response for 19 m/s with and without SJA LCO suppression of a modified Glauert airfoil configuration.

FIG. 9A, FIG. 9B, and FIG. 9C are illustrative examples comprising contours of simulated Z-axis vorticity of a modified Glauert airfoil configuration showing suppression of pitching LCO motion at T=226, T=263, and T=303, respectively.

FIG. 10A and FIG. 10B are illustrative examples comprising simulated and experimentally-observed pressure distributions for a modified Glauert airfoil configuration at AOA=0° and AOA=2°, respectively.

FIG. 11A and FIG. 11B are illustrative examples comprising simulated and experimentally-observed pressure distributions for a modified Glauert airfoil configuration at AOA=4° and AOA=6°, respectively.

FIG. 12A and FIG. 12B are illustrative examples comprising simulated and experimentally-observed pressure distributions for a modified Glauert airfoil configuration at AOA=8° and AOA=10°, respectively.

FIG. 13 shows illustrative examples comprising simulated and experimentally-observed lift curves for a modified Glauert airfoil configuration.

FIG. 14A and FIG. 14B show illustrative examples comprising simulated time histories of pitch and plunge for 2-DOF response of a modified Glauert airfoil configuration at 13.5 m/s.

FIG. 15A and FIG. 15B show illustrative examples comprising simulated time histories of pitch and plunge for 2-DOF free motion of a modified Glauert airfoil configuration at 7 m/s.

FIG. 16A and FIG. 16B are illustrative examples comprising simulated and experimentally-observed pressure coefficient contours for a modified Glauert airfoil configuration at AOA=0° and AOA=2°, respectively.

FIG. 17A and FIG. 17B are illustrative examples comprising simulated and experimentally-observed pressure coefficient contours for a modified Glauert airfoil configuration at AOA=4° and AOA=6°, respectively.

FIG. 18A and FIG. 18B are illustrative examples comprising simulated and experimentally-observed pressure coefficient contours for a modified Glauert airfoil configuration at AOA=8° and AOA=10°, respectively.

FIG. 19 shows illustrative examples comprising simulated lift curves for a modified Glauert airfoil configuration.

FIG. 20A and FIG. 20B show illustrative examples comprising simulated time histories of pitch and plunge for 2-DOF free motion of a modified Glauert airfoil configuration at 7 m/s.

FIG. 21A and FIG. 21B are illustrative examples comprising simulated pressure and streamline contours for a modified Glauert airfoil without SJA actuation and with upper-surface SJA actuation, respectively.

FIG. 22 is an illustrative example comprising a simulated comparison of surface pressure distributions with and without SJA actuation.

FIG. 23A and FIG. 23B are illustrative examples comprising simulated time histories of lift and moment values, respectively, for examples with and without SJA actuation.

FIG. 24A and FIG. 24B show illustrative examples comprising simulated time histories of pitch and plunge for 2-DOF uncontrolled vs. open-loop and closed-loop motion of a modified Glauert airfoil configuration, in sync with pitching frequency.

FIG. 25A and FIG. 25B show illustrative examples comprising simulated time histories of pitch and plunge for 1-DOF uncontrolled vs. 2-DOF open-loop and 1-DOF closed-loop controlled examples, in sync with plunging frequency.

FIG. 26 illustrates generally an example of a technique, such as a machine-implemented method, that can include exposing a modified Glauert airfoil to an airflow having a velocity below a critical flutter speed, the modified Glauert airfoil located in an elastic support system enabling at least plunging motion and extracting energy from sustained oscillations of the at least plunging motion.

FIG. 27 illustrates a block diagram of an example comprising a machine upon which any one or more of the techniques (e.g., methodologies) discussed herein may be performed.

### DETAILED DESCRIPTION

The present subject matter can include or use an airfoil structure. The airfoil configuration can include a wind energy harvesting configuration where the airfoil is mounted in a manner that supports at least one mechanical degree of freedom (1-DOF), such as plunging motion. The airfoil structure can be mounted in a manner supporting multiple degrees of freedom. For example, a 2-DOF configuration can support both pitching and plunging motion as shown and described herein. Energy harvesting can be performed using free motion of the airfoil, or using a control technique, such as including an open-loop approach or closed-loop approach. Such a control technique can include use of at least one actuator, such as a synthetic jet actuator (SJA). Such a control technique is also applicable to flight control, such as for unmanned aerial vehicle (UAV) control that does not require use of moving mechanical control surfaces.

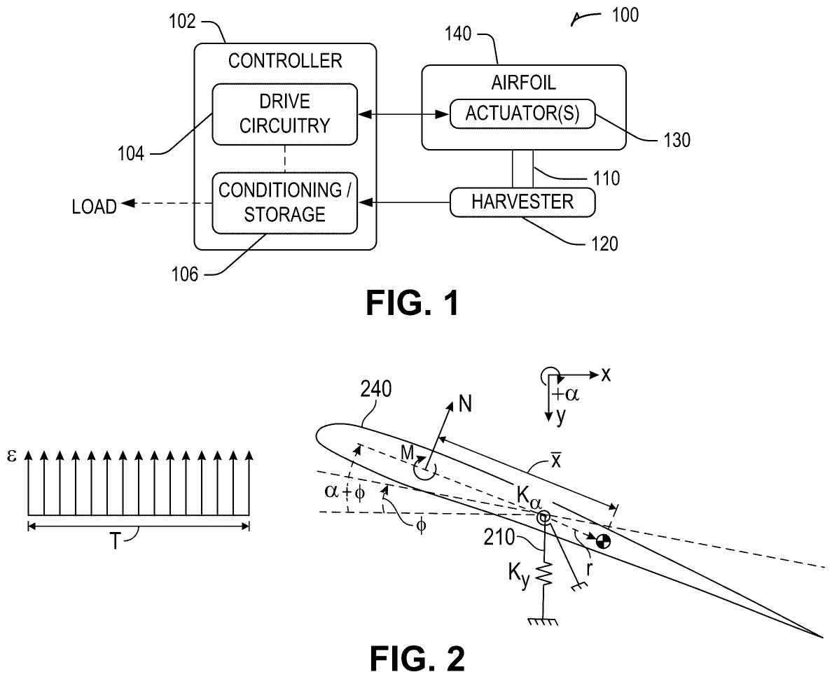

FIG. 1 illustrates generally an example comprising a system 100 that can include an airfoil 140 and a controller circuit 102. The airfoil 140 can be mounted in a manner that allows at least one degree of freedom of mechanical motion, such as for energy harvesting applications. For example, an elastic mounting system 110 can be used to support the airfoil, such as fabricated using a metallic or polymer material that can flex. The elastic mounting system 110 can include or can be mechanically coupled with an electromechanical energy transducer acting as a harvester 120. For example, a piezoelectric energy conversion structure can be used. The airfoil 140 can include a configuration that exhibits cyclic oscillation in response to airflow, such as operating in a free-moving (uncontrolled manner) or using the controller circuit 102 and one or more actuators 130 to sustain cyclic oscillation (e.g., enhancing or inducing limit cycle oscillation behavior).

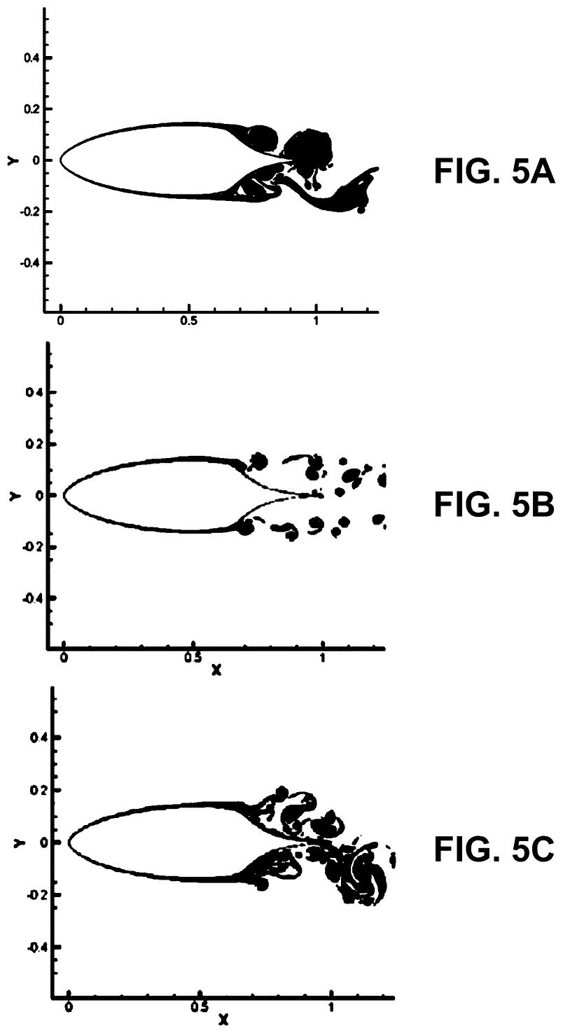

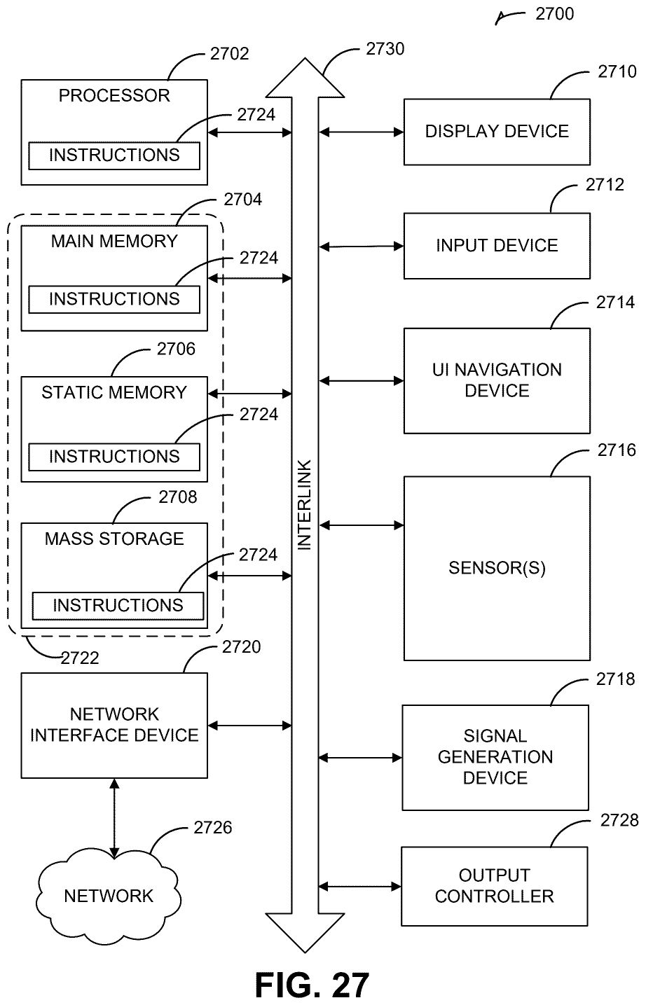

The controller circuit 102 can include drive circuitry 104 such as to control the one or more actuators 130, such as one or more SJAs. The controller circuit 102 can implement one or more methods as shown and described elsewhere herein, such as including an architecture having one or more portions as shown in FIG. 27. Energy generated by the harvester 120 can be conditioned or stored (such as by conditioning circuitry and storage device 106), or otherwise provided to a load. In an example, the controller circuit 102 itself can be powered from energy harvested by the harvester 120 in response to airfoil 140 oscillation. A state of the airfoil can be monitored to provide closed loop control, such as in response to a signal provided by the harvester 120, or otherwise in response to one or more other electromechanical or electrooptical transducers. Various airfoil configurations can be used. As described elsewhere herein, a Glauert airfoil body can be used, such as a “modified” Glauert airfoil configuration having a symmetric profile where an upper surface of the airfoil is mirrored to define a lower surface as shown illustratively in FIG. 4A and FIG. 4B, below.

In general, a closed-loop control scheme can include one or more sensed parameters as inputs to a state estimator. The state estimator can be implemented such as to provide state estimation in “real time” (e.g., with low enough latency to support stable closed-loop control), and an estimated state can be provided as an input to a control law such as shown and described below. The control law can output signals, such as to excite one or more SJAs to perform power extraction.

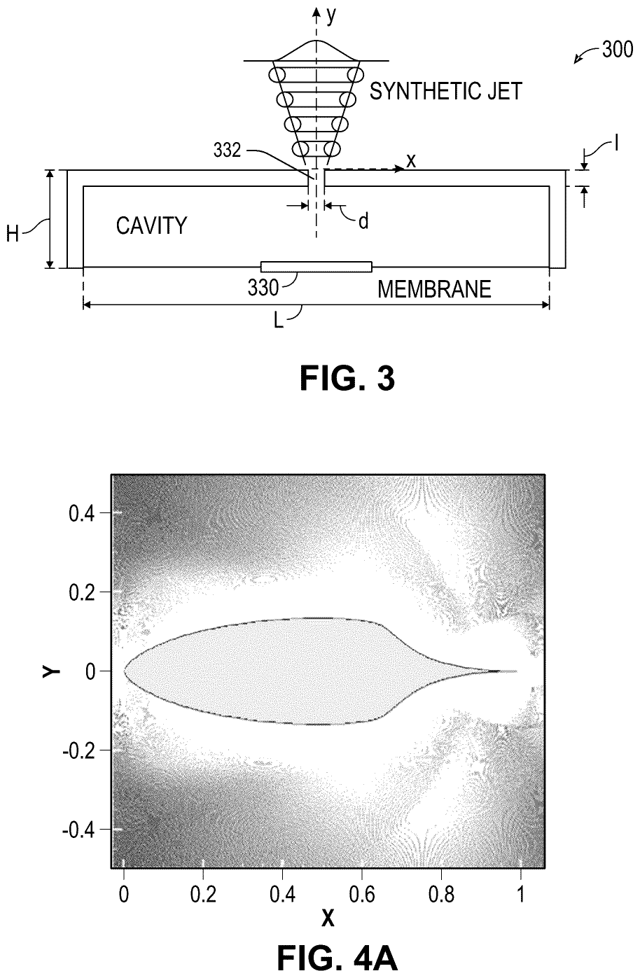

FIG. 2 illustrates generally model variables that can be associated with a two degree of freedom (2-DOF) airfoil 240 excited by an impinging sharp-edge gust. As shown in FIG. 2, an elastic mounting structure 210 can be modeled as a one-DOF structure allowing plunging motion, and a second degree of freedom can be provided by pitching of the airfoil 240 about a pivot location on the elastic mounting structure 210. The example of FIG. 2 does not show a Glauert airfoil configuration, and instead shows an airfoil geometry similar to a NACA-0012 or other streamlined configuration. As shown and described elsewhere herein, a modified Glauert airfoil configuration as shown in FIG. 4A and FIG. 4B allows viscous separation flutter to support plunging oscillations at relatively lower wind speeds as compared to other configurations.

Robust flight control or wind energy harvesting can be achieved using, for example, a distributed array of zero-net-mass-flux synthetic-jet micro-actuators (SJMAs) embedded in an airfoil. The benefits of using SJMAs as opposed to mechanical control (e.g., using ailerons, flaps, elevator, or rudder structures) can include reduced cost and weight with reduced mechanical complexity. As an example, a nonlinear feedback-loop controller can be suitable for systems with high levels of parametric uncertainties present both in unsteady upstream flow conditions and nonlinear dynamics of synthetic-jet interaction with grazing boundary-layer flow. Described herein is an airfoil configuration and control approach focusing on examples involving control of a transitional, elastically-mounted, two-degrees-of-freedom (2-DOF) airfoil entering limit-cycle oscillations (LCO) induced by an impinging upstream vortical flow disturbance (e.g., a sharp-edge gust, as illustrated in FIG. 2). The methodology for evaluation herein includes both low-fidelity and high-fidelity analysis tools for design and prediction of SJMA control authority. The robust controller analysis herein can be used to address parametric uncertainties and nonlinearities in the SJA dynamics. The controller can be easily and inexpensively implementable, requiring no observers, function approximators, or adaptive update laws which might be used in other approaches.

In the examples herein, minimal knowledge of the structure of the SJMA dynamic model is required, with a matrix decomposition technique used along with algebraic manipulation in the controller development such as to compensate for the dynamic uncertainty in the SJMAs. Results of the low-fidelity reduced-order modeling of LCO robust control demonstrated successful LCO suppression that was achieved for a wide range of the airfoil initial excitation amplitudes with the specified set of the controller gains. A low-fidelity study can be extended to include a high-accuracy numerical approach such as employed in gust-response and SJA-based flow control studies. A representative set of structural parameters can be selected to provide a realistic model of elastically-mounted wing section. The high-accuracy analysis of gust-induced LCO transition was augmented through inclusion of surface-embedded SJAs operating in the closed-loop system, with actuation parameters governed by the robust controller. Using the high-accuracy simulations, the success of the implemented robust control strategy was examined as part of the implicit time-marching numerical procedure.

Generally, for examples involving use of an actuator and control scheme, a nonlinear control technique can be capable of either eliminating or sustaining the optimal amplitude of limit cycle oscillations (LCO) induced on an airfoil array, with the latter approach targeting an optimized wind flutter energy extraction system. The fluid forcing function, which is a function of the fluid flow velocity near the surface of the plate, was selected to control the LCO over a range of wind speeds. In a proposed variable-fidelity, nonlinear closed-loop control approach, a proper orthogonal decomposition (POD)-based model reduction technique is first used to recast the Navier-Stokes equations as a set of nonlinear ordinary differential equations in terms of unknown Galerkin coefficients.

The unknown coefficients of the reduced order model are estimated in finite time using a novel sliding mode estimator. These estimates are used as a feedback measurements in a nonlinear control law. In particular, a Lyapunov-based stability analysis was used to prove asymptotic regulation of the flow field velocity to a desired velocity profile, which results in generating the desired fluid forcing function. Preliminary low-fidelity numerical simulation results were obtained to demonstrate the capability of the control system to regulate the fluid forcing function to a desired state, which controls the LCO oscillations. The current subject matter includes a comparison of high-fidelity analysis with experimental work while focusing on steady-state conditions. Results are also demonstrated from high-fidelity numerical experiments conducted for selected cases of separation-dominated 2-DOF LCO of a modified Glauert (MG) airfoil configuration that can be used for effective flow energy extraction from induced plunging motion at low wind speeds.

### Aeroelastic Response Control Model

In general, the equations describing unsteady response of elastically-mounted 2-DOF thin airfoil can be expressed as,

$${M}_{s} \ddot{p} + {C}_{s} \dot{p} + F ( p ) p = [ \begin{matrix}- Lift \\ Moment\end{matrix} ] \qquad EQN . 1$$

where the coefficients Mₛ, Cₛ ∈ [symbol] denote the structural mass and damping matrices, F(p)∈ [symbol] is a nonlinear stiffness matrix, and p(t)∈ [symbol] denotes the state vector. In EQN. 1, p(t) explicitly defined as

$$p = [ \begin{matrix}h \\ α\end{matrix} ] \qquad EQN . 2$$

where h(t), α(t)∈ [symbol] denote the plunging [meters] and pitching [radians] displacements describing the LCO effects. Also in EQN. 1, the structural linear mass matrix Mₛ is defined as

$${M}_{s} = [ \begin{matrix}m & {S}_{α} \\ {S}_{α} & {I}_{α}\end{matrix} ] \qquad EQN . 3$$

where the parameters S_{α}, I_{α}∈ [symbol] are the static moment and moment of inertia, respectively. The structural linear damping matrix is described as

$${C}_{s} = 2 [ \begin{matrix}{ζ}_{h} \sqrt{{k}_{h} m} & 0 \\ 0 & {ζ}_{a} \sqrt{{k}_{α} {I}_{α}}\end{matrix} ] \qquad EQN . 4$$

where the parameters, ζₕ, ζ_{α}∈ [symbol] are the damping logarithmic decrements for plunging and pitching, and m∈ [symbol] is the mass of the wing, or in this case, a flat plate.

A nonlinear stiffness matrix used for the analysis in this document is.

$$F ( p ) = [ \begin{matrix}{k}_{h} & 0 \\ 0 & {k}_{α} + {k}_{{α}^{3}} {α}^{2}\end{matrix} ] \qquad EQN . 5$$

where k_{α}, k_{α}³∈ [symbol] denote structural resistances to pitching (linear and nonlinear) and kₕ∈ [symbol] is the structural resistance to plunging.

In EQN. 1, the total lift and moment are defined as

$$[ \begin{matrix}- Lift \\ Moment\end{matrix} ] = [ \begin{matrix}- ( L + {L}_{{v}_{i}} ) \\ ( M + {M}_{{v}_{j}} )\end{matrix} ] = {M}_{a} \ddot{p} + {C}_{a} \dot{p} + {K}_{a} p + {L}_{η} η + B δ \qquad EQN . 6$$

where δ=[−Lᵥⱼ; Mᵥⱼ]∈ [symbol] denote the equivalent control force and moment, respectively due to the virtual surface deflection generated by jth SJMA, and L, M∈ [symbol] are the aerodynamic lift and moment due to 2-DOF motions.

In EQN. 6, η∈ [symbol] denotes the aerodynamic state vector that relates the moment and lift to the structural modes. Also, in EQN. 6, the aerodynamic and mode matrices Mₐ, Cₐ, Kₐ, L_{η}∈ [symbol] are described as

$${M}_{a} = πρ {b}^{2} [ \begin{matrix}- 1 & ba \\ ba & - {b}^{2} ( \frac{1}{8} - {a}^{2} )\end{matrix} ] \qquad EQN . 7$$

$${C}_{a} = πρ {b}^{2} [ \begin{matrix}0 & - U \\ 0 & - Ub ( \frac{1}{2} - a )\end{matrix} ] + 2 πρ Ub ϕ ( 0 ) [ \begin{matrix}\vert - 1 & - b ( \frac{1}{2} - a ) \\ b ( \frac{1}{2} + a ) & {b}^{2} ( \frac{1}{2} + a ) ( \frac{1}{2} - a )\end{matrix} ] \qquad EQN . 8$$

$${K}_{a} = 2 πρ Ub ϕ ( 0 ) [ \begin{matrix}0 & - U \\ 0 & b ( \frac{1}{2} + a ) U\end{matrix} ] \qquad EQN . 9$$

$${L}_{η} = 2 πρ Ub [ \begin{matrix}{a}_{1} {b}_{1} & {a}_{2} {b}_{2} \\ - b ( \frac{1}{2} + a ) {a}_{1} {b}_{1} & - b ( \frac{1}{2} + a ) {a}_{2} {b}_{2}\end{matrix} ] \qquad EQN . 10$$

where ϕ(0) is the Wagner solution function at 0, and the parameters a₁, b₁, a₂, b₂∈ [symbol] are the Wagner coefficients. The aerodynamic state variables are governed as follows.

$$\dot{η} = {C}_{η} \dot{p} + {K}_{η} p + {S}_{η} η \qquad EQN . 11$$

The aerodynamic state matrices in EQN. 11, C_{η}, K_{η}, S_{η}∈ [symbol] , are explicitly defined as follows.

$${C}_{η} = [ \begin{matrix}- 1 & - b ( \frac{1}{2} - a ) \\ - 1 & - b ( \frac{1}{2} - a )\end{matrix} ] \qquad EQN . 12$$

$${K}_{η} = \frac{U}{b} [ \begin{matrix}0 & - U \\ 0 & - U\end{matrix} ] \qquad EQN . 13$$

$${S}_{η} = \frac{U}{b} [ \begin{matrix}- {b}_{1} & 0 \\ 0 & - {b}_{2}\end{matrix} ] \qquad EQN . 14$$

By substituting EQN. 6 into EQN. 1 the LCO dynamics can be expressed as

$$M \ddot{p} = - C \dot{p} - Kp + {L}_{η} η + B δ \qquad EQN . 15$$

$$where C = {C}_{s} - {C}_{a} , K = F ( p ) - {K}_{α} and M = {M}_{s} - {M}_{a} .$$

A control signal can be generated to regulate the plunging and pitching dynamics (e.g., h(t), α(t)) to zero or a specified (e.g., fixed) value. To facilitate analysis of the generation of the control signal, the expression in EQN. 15 is rewritten as

$$M \ddot{p} = g ( h , α , η ) + Bu \qquad EQN . 16$$

where g(h,α,η) can represent an unknown, unmeasurable auxiliary function. To quantify the control objective, a regulation error, e₁(t)∈ [symbol] , and auxiliary tracking error variables, e₂(t), r(t)∈ [symbol] , can be defined as

$${e}_{1} = p - {p}_{d} \qquad EQN . 17$$

$${e}_{2} = {\dot{e}}_{1} + {α}_{1} {e}_{1} \qquad EQN . 18$$

$$r = {\dot{e}}_{2} + {α}_{2} {e}_{2} \qquad EQN . 19$$

where α₁, α₂>0∈ [symbol] are configurable (e.g., user-definable) control gains, and the desired plunging and pitching states p_{d}=0 for the plunging and pitching suppression objective (as an example). Based on open loop error dynamics, the control input was established via

$$\dot{u} = {B}^{- 1} ( - ( {k}_{s} + {I}_{2 \times 2} ) r - β sgn ( {e}_{2} ( t ) ) \qquad EQN . 20$$

where kₛ, β∈ [symbol] denote constant, positive definite, diagonal control gain matrices, and I_{2×2} denotes a 2×2 identity matrix. Note that the control input u(t) does not depend on an unmeasurable acceleration term r(t), because EQN. 20 can be directly integrated to show that u(t) depends on measurements of e₁(t) and e₂(t) only, in this example. Using the established robust control law, a reduced-order model was implemented that showed successful LCO suppression for a selected benchmark case. Further validation was performed based on 2-DOF inviscid flat-plate dynamics. In particular, a high-fidelity model was developed to study the aeroelastic response and robust LCO control for a realistic 2-DOF viscous airfoil with embedded SJMAs.

### Fluid Dynamic Model

To demonstrate the SJMA-based robust aeroelastic control, a high-fidelity numerical approach is shown herein as an illustrative example, using a modified version of the Implicit Large Eddy Simulation (ILES) Navier-Stokes solver FDL3DI. The following features of the original version of the code are useful for the current analysis of fluid-structure interaction and its control. Such aspects include: implicit time marching algorithms (up to 4th-order accurate), suitable for the low-Reynolds number wall-bounded flows characteristic of MAV airfoils; high-order spatial accuracy (up to 6th-order accurate) achieved by use of implicit compact finite-difference schemes, thus making LES resolution attainable with minimum computational expense; and robustness achieved through a low-pass Pade-type non-dispersive spatial filter that regularizes the solution in flow regions where the computational mesh is not sufficient to fully resolve the smallest scales.

The governing equations are represented in the original unfiltered form used unchanged in laminar, transitional or fully turbulent regions of the flow. The highly efficient Implicit LES (ILES) procedure employs a high-order filter operator in lieu of the standard SGS and heat flux terms, with the filter selectively damping the evolving poorly-resolved high-frequency content of the solution. FDL3DI can also use an overset grid technique adopted for geometrically complex configurations, with high-order interpolation maintaining spatial accuracy at overlapping mesh interfaces. The code employs an efficient MPI parallelization that has been successfully used on various Beowulf cluster platforms in our previous studies.

### Numerical Implementation

The modeling discussed herein was used to simulate the coupled unsteady aerodynamic and acroclastic responses of 1-DOF and 2-DOF elastically-mounted airfoils and their transition to LCO induced by an impinging gust (as shown schematically in FIG. 2). The acroclastic response module has been implemented within the framework of the viscous flow solver. In the numerical formulation, the equations governing the fluid dynamics are coupled with equations governing 1-DOF or 2-DOF airfoil motion so that the fluid and structure are treated as a single dynamical system. In the time-marching procedure, the aerodynamic loads are supplied through Navier-Stokes simulations while the structural response element determines the displacement vector which, in turn, defines the grid motion. At each physical time step, the internal iterative loop achieves the balance of the new airfoil position and the corresponding unsteady flow field. The loop is efficiently merged with the sub-iterative procedure implemented as part of the flow solver's implicit time marching scheme.

### Impinging Sharp Edge Gust Model

In the illustrative examples herein, the airfoil LCO is induced by an impinging sharp-edge gust as shown in FIG. 2. The model is analytically described in terms of the upwash velocity profile (with the streamwise component u_{g}(x,t)=0) in EQN. 21, below.

$${v}_{g} ( x , t ) = \{ \begin{matrix}{ε}_{g} f ( t - x / {u}_{∞} ) , & {u}_{∞} ( t - {T}_{g} ) \leq x \leq {u}_{∞} t \\ 0 , & otherwise\end{matrix} \qquad EQN . 21$$

In numerical simulations, the gust is generated with a prescribed duration T_{g} and the gust amplitude, ε_{g}, in the momentum source region located upstream of the airfoil and undergoes ramp-up and ramp-down phases similar to natural flows as represented by function ƒ in EQN. 21.

### SJMA Model

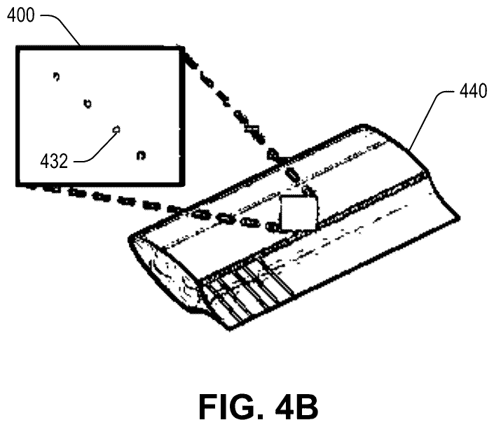

FIG. 3 illustrates generally an example comprising a synthetic jet actuator (SJA) 300 (e.g., a synthetic jet micro-actuator (SJMA)) that can be included or used in association with an airfoil, such as to provide controllability of the airfoil. The SJA 300 can be controlled such as using an electromechanical actuator 330, such as a piezoelectric device, where the jet is modulated at a port 332.

Active LCO control using synthetic micro-jets can be validated through investigation of effectiveness of SJMA for active control of unsteady flow over an SD7003 low-Re airfoil in presence of a sharp-edge gust, as an illustrative example. In the numerical procedure, the actuator's orifice with a properly defined fluctuating-velocity boundary condition specified by EQN. 22 is embedded into the airfoil surface to allow for the synthetic jet to freely interact with the grazing boundary-layer flow. In the simulations described herein, the fluctuating-velocity boundary condition is prescribed directly on the airfoil surface to minimize complexities allowing for a parametric analysis of optimized SJMA locations to be performed.

$${v}_{SJA} ( x , t ) = A cos ( {ω}_{SJA} t ) \qquad EQN . 22$$

### “Modified” Glauert (MG) Airfoil Configuration

FIG. 4A illustrates generally an illustrative example of an airfoil configuration having a symmetrical profile defining an upper surface and a lower surface, along with associated numerical grid used for numerical simulations described herein and FIG. 4B illustrates generally an illustrative example of an airfoil 440 configuration (e.g., a modified Glauert configuration) and synthetic jet actuator 400 port 432 locations.

A high-accuracy viscous study explored SJMA-based robust control of gust-induced LCO by comparing SJMA-induced unsteady responses of NACA-0012 airfoil and an airfoil defined by mirroring a Glauert airfoil upper surface profile to the lower surface to obtain a symmetric airfoil. This is referred to generally herein as the modified Glauert (MG) airfoil.

The present subject matter focuses MG airfoil analysis because LCO control can be achieved, including at lower wind speeds (e.g., below a critical flutter speed otherwise predicted by inviscid theory). The MG airfoil baseline 1363×789×3 O-grid is illustrated in FIG. 4A. By comparison with the configuration shown in FIG. 4A, a standard Glauert airfoil is configured to have a large, separated region in the aft section of the airfoil, which is generally detrimental to the aerodynamic performance. However, when an SJMA is placed and actuated at a location near the separation region, a notable improvement in the aerodynamic response can be achieved through flow reattachment (e.g., modification of flow attached characteristics) that can also produce a significant change in the aerodynamic moment. The MG airfoil tested in this work thus appears adequate for LCO control studies based on the improved control authority characteristics. The boundary conditions for simulation comprise a no-slip wall with 4th-order

extrapolation at the airfoil surface, periodicity along the span, and a freestream condition imposed at the far-field boundary located more than 100 chords away from the airfoil, with the grid rapidly stretching towards that boundary to ensure effective elimination of spurious reflections achieved in conjunction with the low-pass spatial filtering. A fixed time step of t_{Δ}=9×10⁻⁵ was used in the code parallel simulations, with the baseline mesh efficiently partitioned into a set of 784 overlapped blocks assigned to different processors. Such computations required about 40 CPU hours on a DOD HPC system to establish a clearly-defined LCO in approximately 2×10⁶ time steps.

### LCO Suppression Case Study

A parametric study was previously carried out as one approach for determining an optimal location for control of the flow in the separated regions. This was performed by placing the airfoil at an angle of attack, AOA=0 deg and running a simulation for 20 characteristic cycles at Ms=0.056 and Re=180,000 to find separation locations. The numerical results predicted the separation point located at approximately 64% chord, similar to experimental findings. Placing the SJA directly at the separation region generally does not provide the desired results. The SJA location was varied until an optimal location was found, and a parametric investigation revealed that the optimized location existed at around 68% chord for the MG airfoil design. The airfoil had two embedded actuators installed at the specified location at around 68% chord, one on top and one on the bottom. Generally, according to various examples herein, an SJA location in the range of about 67% to about 68% chord showed best performance for the MG airfoil configuration.

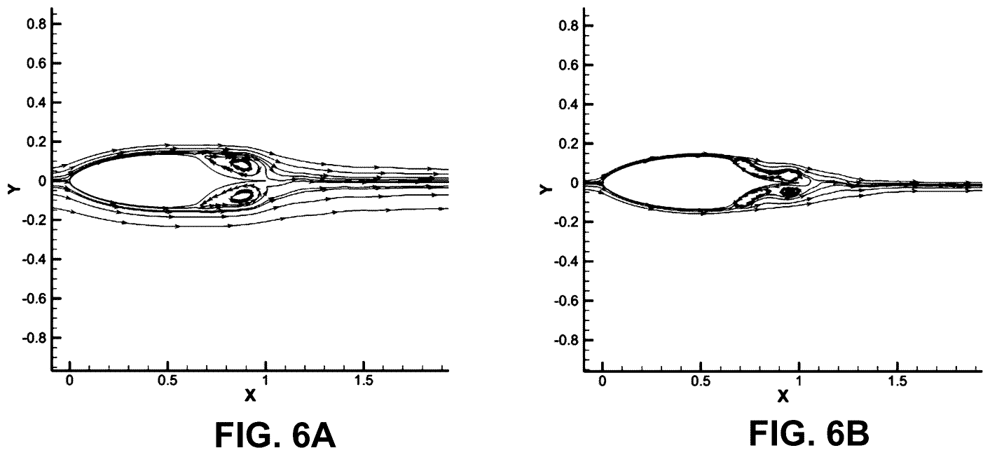

FIG. 5A, FIG. 5B, and FIG. 5C are illustrative examples comprising contours of simulated Z-axis vorticity for modified Glauert airfoil configurations having no SJA, a non-optimized SJA location, and an optimized SJA location, respectively. The contours show that the optimized SJA location has much weaker vorticity formed in the aft section of the airfoil.

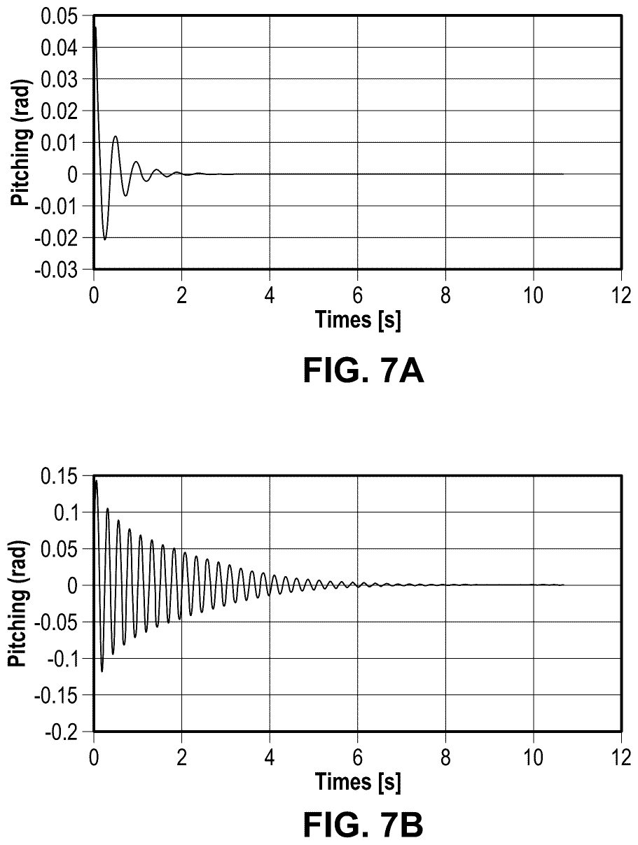

FIG. 6A and FIG. 6B are illustrative examples comprising contours of simulated time-averaged U-velocity contours for modified Glauert airfoil configurations having a non-optimized SJA location, and an optimized SJA location, respectively. The U-velocity contours reveal a much smaller recirculation area in the aft section of the airfoil with a more streamlined flow pattern.

The same representative set of the aeroelastic model parameters previously employed and shown in TABLE 1, below, is used to provide a realistic model of elastically-mounted MG airfoil wing section. These structural parameters match with experimental study which indicated a critical (flutter) speed of about 16 m/s in the test case performed for NACA0010 airfoil and used as a benchmark for validation of the numerical approach. The robustness of the controller was first validated in a series of simulations where the control gains were kept constant for several different freestream velocities. The phrase “critical” or “critical flutter speed” used herein refers to a flow velocity at which natural oscillation of an airfoil will occur and can become self-sustaining. This should not be confused with critical Mach number, which is an unrelated concept.

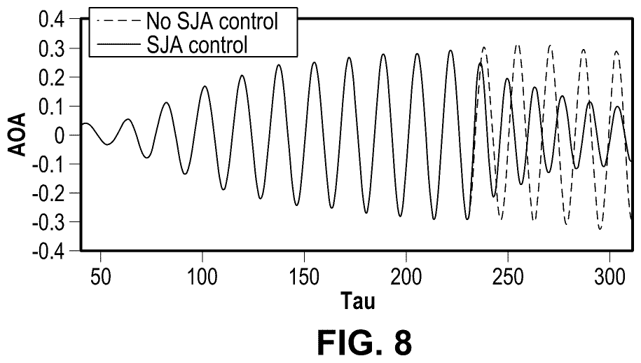

FIG. 7A and FIG. 7B are illustrative examples comprising simulated suppression pitching limit cycle oscillations (LCO) of a modified Glauert airfoil configuration, with suppression achieved by the feedback-loop robust control system with increasing freestream velocities (U=18.25, 28.5 m/s). The results show the expected trend of increased time required to suppress LCO at higher flight speeds.

TABLE 1
Illustrative example comprising parameters
for a 2-DOF aeroelastic model.

| | | |
|---|---|---|
| ρ = 1.1 kg/m³ | b = 0.11 m | a = −0.024 m |
| m = 2.55 kg | a₁ = 0.165 | a₂ = 0.0455 |
| Sₐ = 1.04 × 10⁻² kg · m | b₁ = 0.335 | b₂ = 0.300 |
| Iₐ = 2.51 × 10⁻³ kg · m | kₐ = 9.3 N/m | kₐ_{³} = 55 N/m |
| kₕ = 450 N/m | ζₕ = 5.5 × 10⁻³ | ζₐ = 1.8 × 10⁻² |

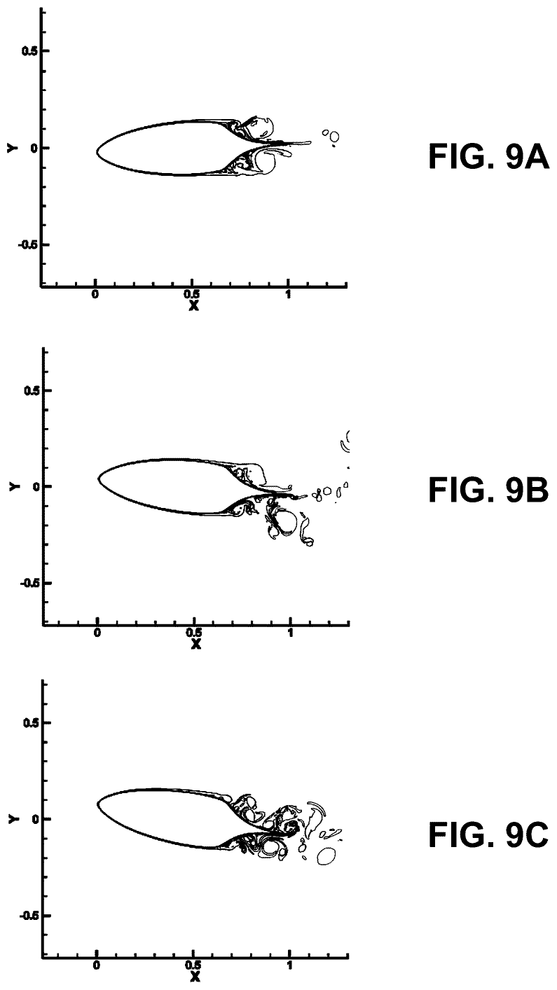

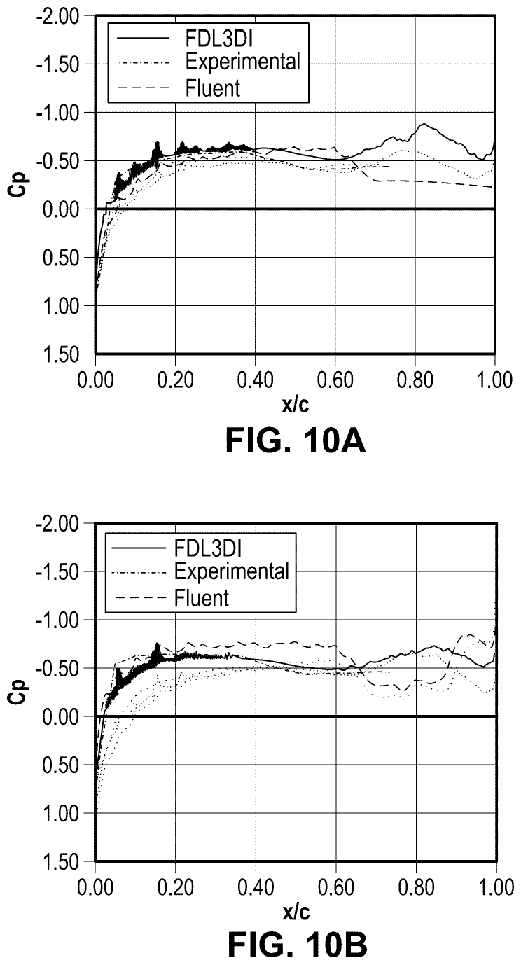

FIG. 8 is an illustrative example comprising simulated time histories of pitching response for 19 m/s with and without SJA LCO suppression of a modified Glauert airfoil configuration. FIG. 9A, FIG. 9B, and FIG. 9C are illustrative examples comprising contours of simulated Z-axis vorticity of a modified Glauert airfoil configuration showing suppression of pitching LCO motion at T=226, T=263, and T=303, respectively.

The results for the 1-DOF pitching LCO control were then obtained as part of the time-accurate viscous simulations conducted for MG airfoil at 19 m/s. To excite the unsteady airfoil response, a sharp-edge gust shown as shown in FIG. 2 with prescribed duration T_{g}=5 and gust amplitude ε_{g}=0.5 was introduced 1.5 chords upstream at T=35 to provide the initial disturbance forcing the airfoil into LCO. The time history of the airfoil pitching response is shown in FIG. 8, with instantaneous z-vorticity contours illustrated in FIG. 9A, FIG. 9B, and FIG. 9C.

As shown in FIG. 9A, FIG. 9B, and FIG. 9C, the flow in the aft section of the airfoil is highly separated and benefits from SJMAs for reattaching the flow, thus ultimately controlling LCO. For all actuation cases, the amplitude and non-dimensional angular actuation frequency in EQN. 22 were A=2.0 and ωₛⱼₐ=20, which is four times higher than a natural shedding frequency ω_{shedding}=5. The actuation frequency was specified based on a comparative study in which several actuation frequencies were investigated, ranging from 5 through 40. The study revealed that between ωₛⱼₐ=5 and ωₛⱼₐ=10, very little change was observed in the aerodynamic response. However, when the actuation frequency was increased to 20, the flow patterns changed, and the aerodynamic response showed the actuation to be dominating the flow. The increase from ωₛⱼₐ=20 to ωₛⱼₐ=40 did not show any significant differences.

The robust controller simulation solution was obtained by using results from the uncontrolled computations as the input and in this example, the output file from the uncontrolled case at T=230 was used. The difference between the controlled and uncontrolled case is shown in FIG. 8. The pitching motion shows no differences between the two cases initially at T=230, however as the controller begins to drive the SJMAs, the results begin to deviate substantially. The results show the controller to successfully reduce the pitching LCO motion between T=230 and T=300. The reduction in pitching amplitudes also resulted in a significant drop in the moment response.

### Comparison of Numerical vs Experimental Results at Steady-State Conditions

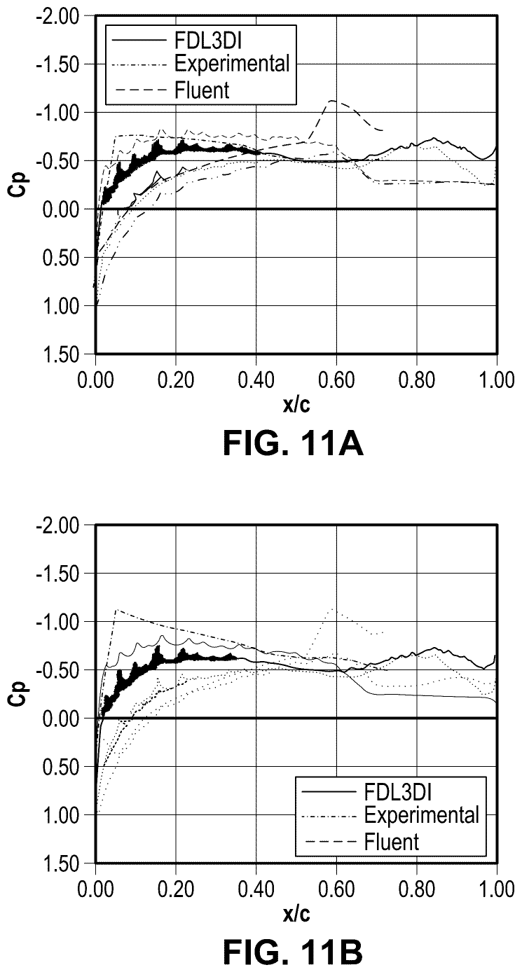

FIG. 10A and FIG. 10B are illustrative examples comprising simulated and experimentally-observed pressure distributions for a modified Glauert airfoil configuration at AOA=0° and AOA=2°, respectively.

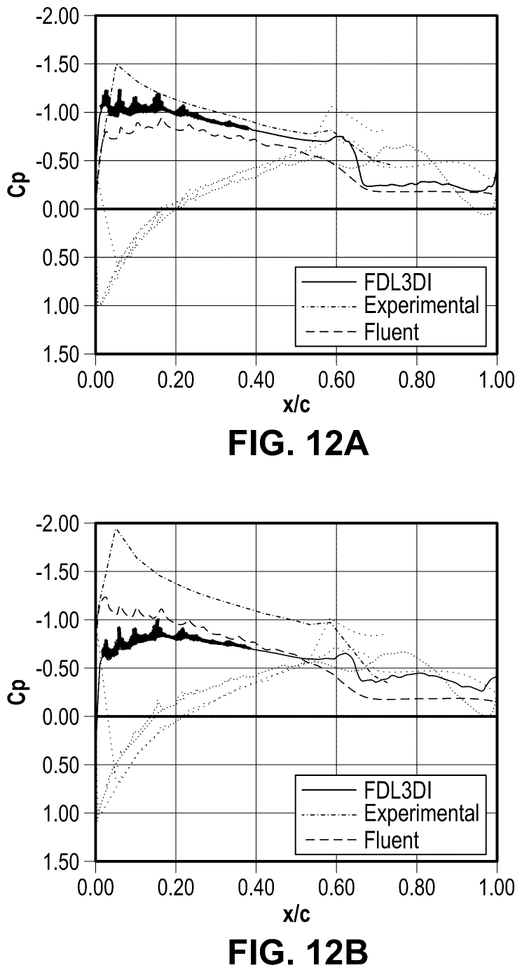

FIG. 11A and FIG. 11B are illustrative examples comprising simulated and experimentally-observed pressure distributions for a modified Glauert airfoil configuration at AOA=4° and AOA=6°, respectively.

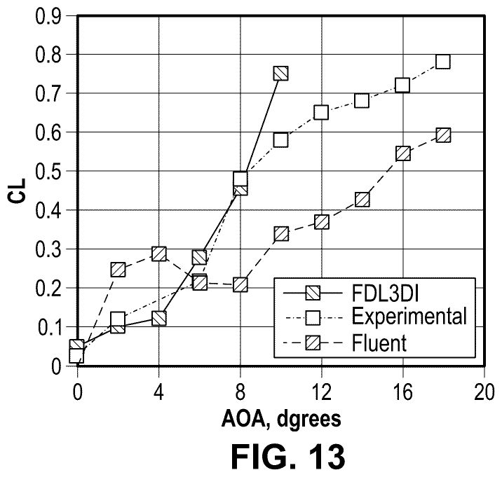

FIG. 12A and FIG. 12B are illustrative examples comprising simulated and experimentally-observed pressure distributions for a modified Glauert airfoil configuration at AOA=8° and AOA=10°, respectively.

The numerical studies include FDL3DI (ILES) and Ansys Fluent (k-ω RANS) simulations, with the latter using an unstructured mesh. The experimental data was collected over 70% of chord from the leading edge. The resulting pressure distributions are compared based on the time-averaged numerical output. Along a lower surface of the airfoil, the experimental and both numerical results agree reasonably well up to AOA=4 deg but show more divergence at higher angles of attack. Near the trailing edge, at low angles of attack, both the upper and lower surfaces maintain low pressure regions aft of the natural separation region of the MG airfoil around 68% of chord. At higher angles of attack, the separation on the upper surface starts to develop before that region, hence the pressure levels on the upper surface switches above those observed on the lower surface. The values below in TABLE 2 were used for simulation.

TABLE 2
Illustrative example of parameters for a steady state simulation
to build lift curves for comparison with experimental data.

| | |
|---|---|
| U_{∞} = 12 m/s | |
| ρ_{∞} = 1.14 kg/m³ | μ_{∞} = 1.841 × 10⁻⁵ Pa · s |
| P_{∞} = 98 kPa | Re = 180,000 |
| T_{∞} = 299 K | M = 0.0346 |

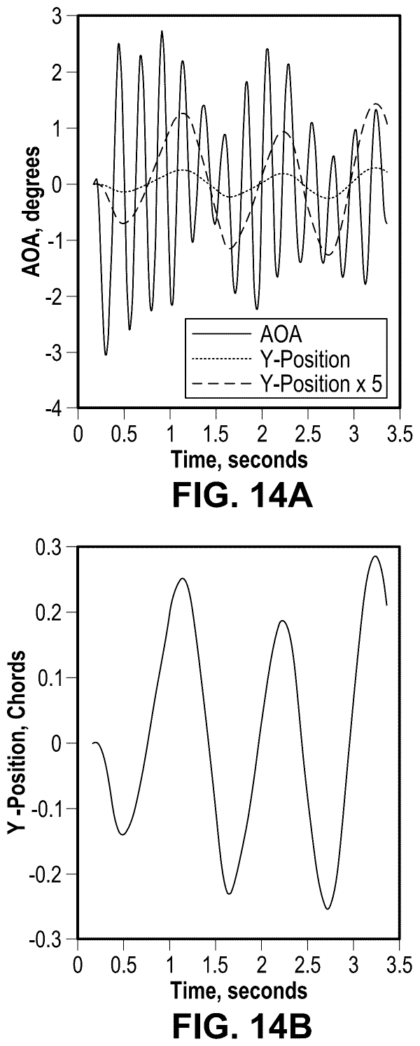

FIG. 13 shows illustrative examples comprising simulated and experimentally-observed lift curves for a modified Glauert airfoil configuration. The lift curve comparison in FIG. 3 illustrates that FDL3DI results generally agree with the experimental data better than Fluent, at low angles of attack (up to 8 deg.). Fluent, in part due to the larger pressure difference between the two surfaces from 40% to 60% chord, overpredicts lift at low angles of attack. By contrast, at higher angles of attack, Fluent shows a more consistent region where the surface pressure is lower than that on the upper surface, leading to the underprediction of drag as AOA increases.

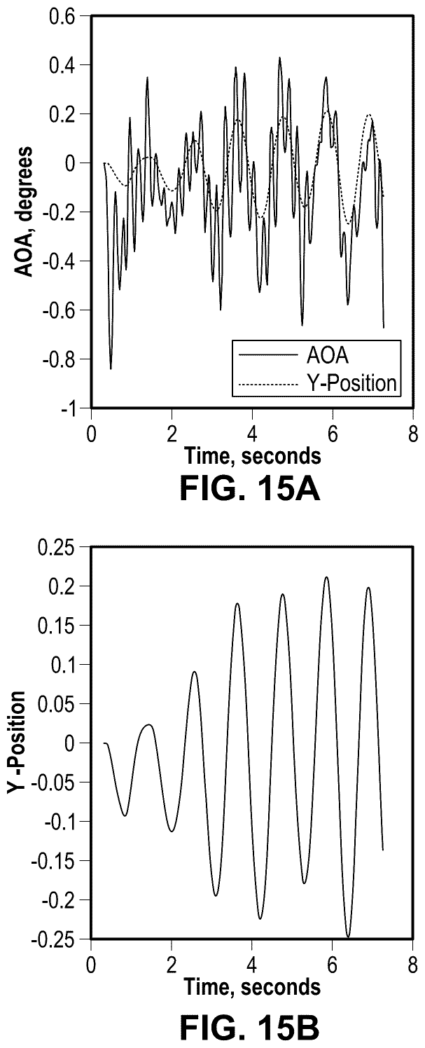

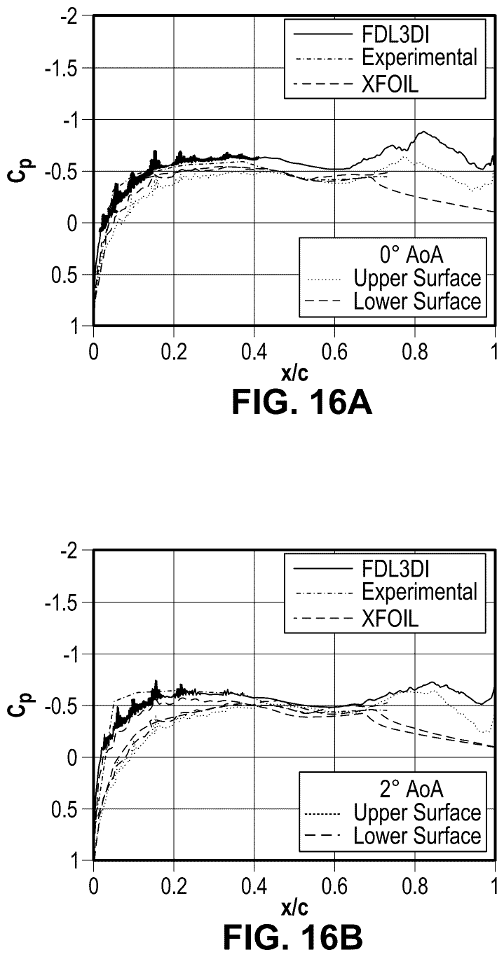

FIG. 14A and FIG. 14B show illustrative examples comprising simulated time histories of pitch and plunge for 2-DOF response of a modified Glauert airfoil configuration at 13.5 m/s and FIG. 15A and FIG. 15B show illustrative examples comprising simulated time histories of pitch and plunge for 2-DOF free motion of a modified Glauert airfoil configuration at 7 m/s.

### 2-DOF LCO Results

Extending the work involving evaluating 1-DOF pitching motion, the plunging mode was activated to examine the uncontrolled 2-DOF response of the MG airfoil at two speeds, 13.5 m/s and 7 m/s, corresponding to Reynolds numbers of 201,000 and 104,200, respectively. The same structural parameters employed TABLE 1, above, were used. To initiate the airfoil motion, a sharp edge gust of T_{g}=9 (at 0.16 s for 13.5 m/s, and at 0.31 s for 7 m/s) was used similar to other examples. For the 13.5 m/s case, shown in FIG. 14A and FIG. 14B, a fundamental frequency of pitching motion was 4.3 Hertz (Hz), and 0.9 Hz for plunging. Comparing the pitching and plunging responses, the two are co-plotted in FIG. 14A, also including the amplified plunging response in FIG. 14B to better highlight the degree of coupling between the two modes of motion.

At 7 m/s, the pitching and plunging frequencies are 5.6 Hz and 1.1 Hz, respectively, as seen in FIG. 15A and FIG. 15B. At this low flow speed, the coupling between the pitching and plunging responses is apparent. Compared with 13.5 m/s examples above, the pitching amplitude has decreased from ±3° to around ±0.5°, while the plunging amplitude for both cases reaches about 0.2 chord lengths from the neutral position. Thus, these results reveal that a minimal pitching response is sufficient to maintain significant plunging amplitude at a relatively low flow speed for the examined structural airfoil properties.

In general, the examples above show capability for wind energy extraction based on the sustained plunging LCO at low wind speeds. An MG airfoil configuration was evaluated to enable the controlled LCO by using an array of SJA actuators producing an aerodynamic moment through an induced flow reattachment effect. The current subject matter extended the previous analyses to include the comparison of the static aerodynamic results of high-fidelity analyses with experimental work, with a good agreement revealed up to AOA of 8 deg. The results of uncontrolled 2-DOF LCO studies at two flow velocities corresponding to 13.5 m/s and 7 m/s revealed a strong coupling between the two modes of motion. Furthermore, a minimal pitching response was sufficient to maintain a significant plunging amplitude at the lowest flow speed for the current choice of structural airfoil properties.

Further Numerical Simulation Findings according to Illustrative Examples

Further case studies were conducted for a range of angles of attack (AOA) 0° to 10° angle of attack in 2° increments, with the resulting pressure distributions presented and compared against XFOIL (available from Massachusetts Institute of Technology) predictions and experimental data.

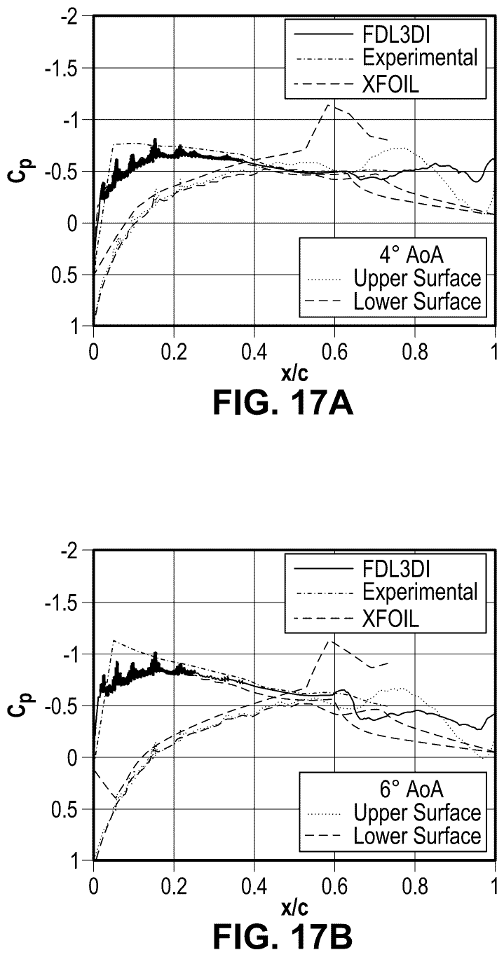

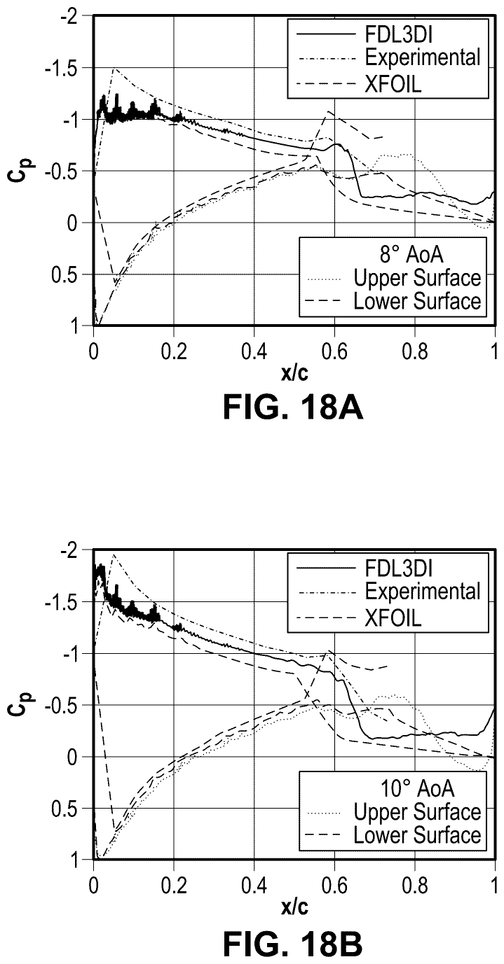

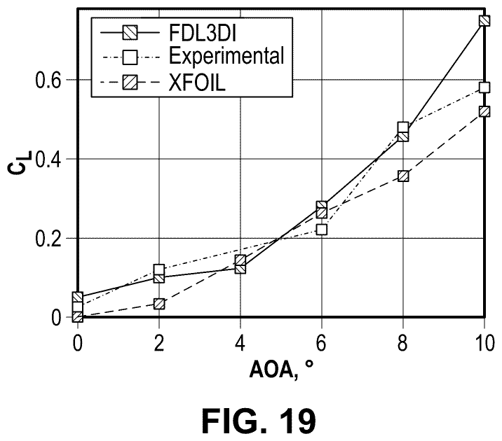

FIG. 16A and FIG. 16B are illustrative examples comprising simulated and experimentally-observed pressure coefficient contours for a modified Glauert airfoil configuration at AOA=0° and AOA=2°, respectively. FIG. 17A and FIG. 17B are illustrative examples comprising simulated and experimentally-observed pressure coefficient contours for a modified Glauert airfoil configuration at AOA=4° and AOA=6°, respectively. FIG. 18A and FIG. 18B are illustrative examples comprising simulated and experimentally-observed pressure coefficient contours for a modified Glauert airfoil configuration at AOA=8° and AOA=10°, respectively.

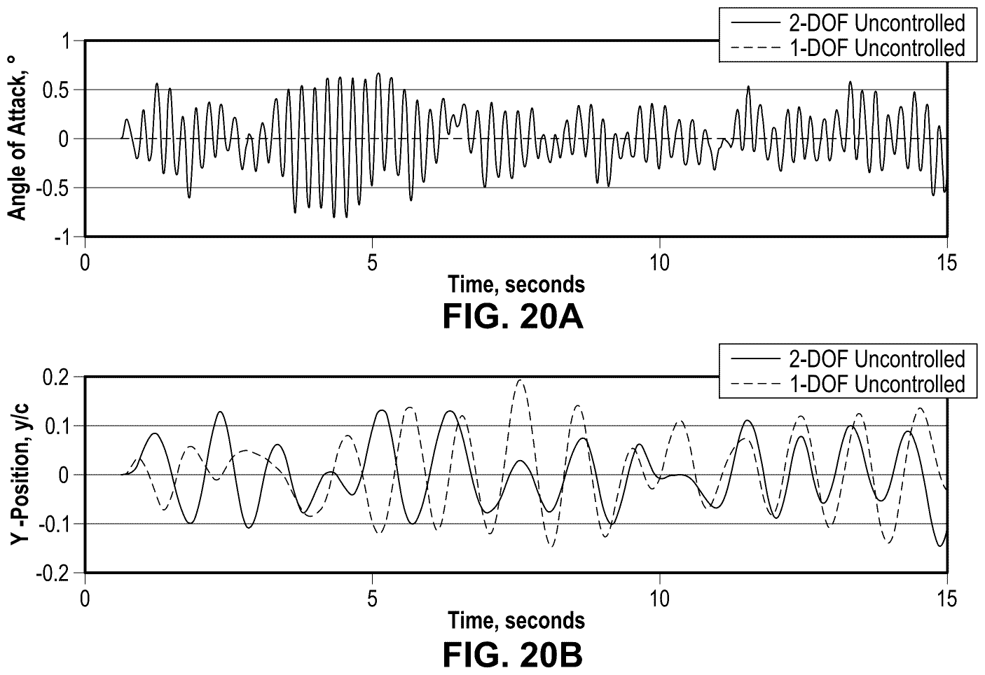

FIG. 19 shows illustrative examples comprising simulated and experimentally-observed lift curves for a modified Glauert airfoil configuration.

As in the examples discussed elsewhere herein, high-fidelity FDL3DI predictions generally follow the experimental data from the leading edge past the mid-chord of the airfoil where such data is available. The observed noise in the numerical data is believed to be a consequence of interpolating the coordinate points defining the airfoil geometry to a much denser numerical grid. The XFOIL panel-method predictions with viscous correction also compare well with FDL3DI results through the mid-chord region, however generally overpredict the surface pressure in the separated region towards the trailing edge. The latter comparison improves at higher angles of attack. The integrated surface pressure data provided with a generally satisfactory lift curve comparison, as shown in FIG. 19. Among other things, these results indicate XFOIL code ability to predict well the overall trends in the MG airfoil aerodynamic response.

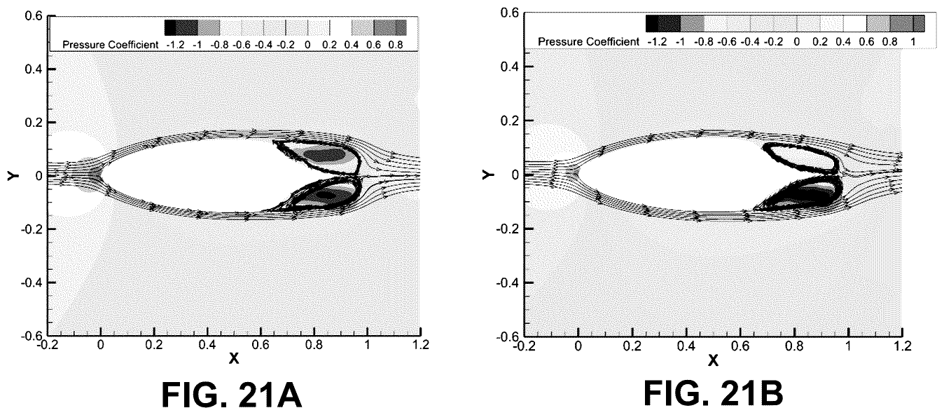

FIG. 20A and FIG. 20B show illustrative examples comprising simulated time histories of pitch and plunge for 2-DOF free motion of a modified Glauert airfoil configuration at 7 m/s. Further LCO analysis was conducted to examine the uncontrolled 2-DOF pitching/plunging airfoil dynamics, at the subcritical upstream flow velocity of 7 m/s (Re=104,200). The natural laminar separation induced by the MG airfoil shape leads to the sustained LCO despite the free-stream velocity being below the critical flutter speed as predicted by the inviscid theory and confirmed by experimental and numerical data. Based on 2-DOF uncontrolled-case analysis, the time-averaged pitching and plunging frequencies of 4.51 Hz and 1.01 Hz, respectively, were recorded. Further analysis showed that both modes of motion did not reveal a strong coupling, so that the complete removal of the pitching DOF resulted in a similar amplitude and overall behavior of plunging motion, as seen in FIG. 20A and FIG. 20B.

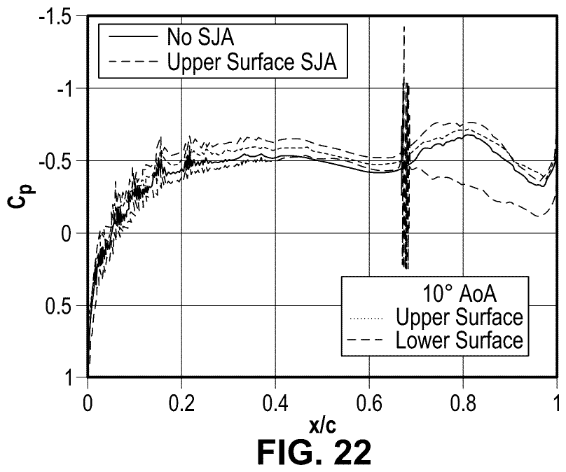

FIG. 21A and FIG. 21B are illustrative examples comprising simulated pressure and streamline contours for a modified Glauert airfoil without SJA actuation and with upper-surface SJA actuation, respectively. The airfoil static response to SJA actuation was examined. The synthetic jet operating at 200 Hz with the exit jet velocity amplitude of 13.5 m/s was modeled as a velocity boundary condition applied on both airfoil surfaces at around 67.5% chord position (close to the natural separation point). Following the converged steady state, the airfoil flow was simulated for 4 sec in a static position with the free-stream velocity of 7 m/s without SJA actuation before the upper-surface jet was activated for another 4 sec. The corresponding time-averaged solutions for each flow regime resulted in the pressure and streamline contours is compared in FIG. 21A and FIG. 21B.

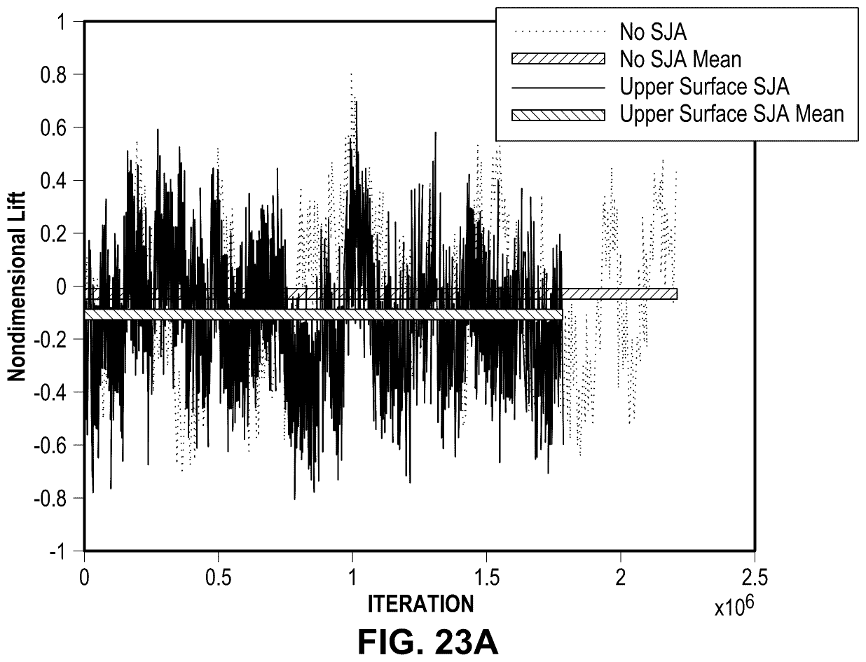

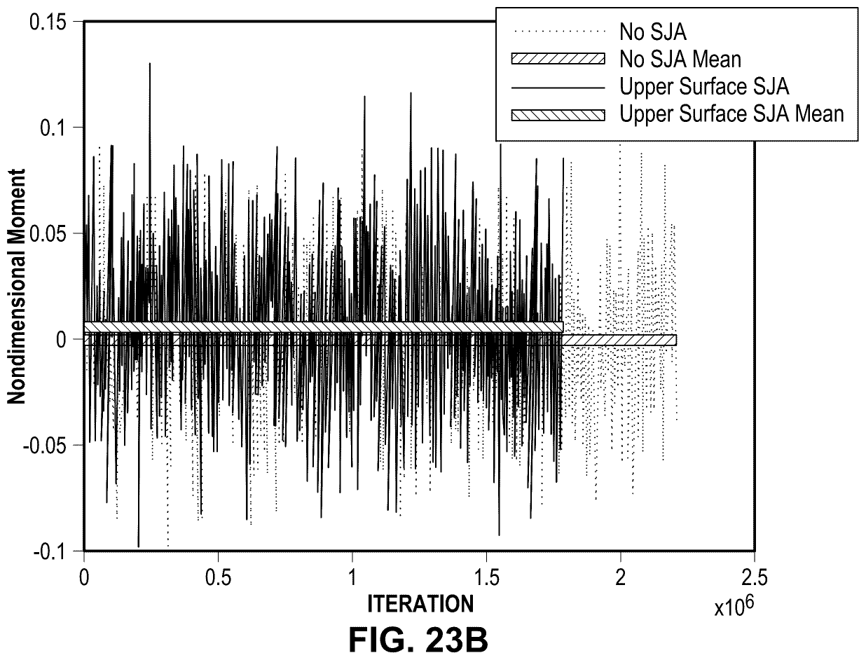

FIG. 22 is an illustrative example comprising a simulated comparison of surface pressure distributions with and without SJA actuation and FIG. 23A and FIG. 23B are illustrative examples comprising simulated time histories of lift and moment values, respectively, for examples with and without SJA actuation. SJA activation reduces the size of the separated region (though not completely reattaching the flow), resulting in a significant increase in pressure on the actuated upper surface, as seen in FIG. 22. This leads to decreased lift and a positive pitching moment, which thus substantiates the LCO control using optimized alternating-surface SJA actuation (e.g., in synchronization with a fundamental frequency oscillation).

FIG. 23A and FIG. 23B are illustrative examples comprising simulated time histories of lift and moment values, respectively, for examples with and without SJA actuation. The changes in the airfoil aerodynamic response are also evident from the comparison of the lift and moment time histories in FIG. 23A and FIG. 23B.

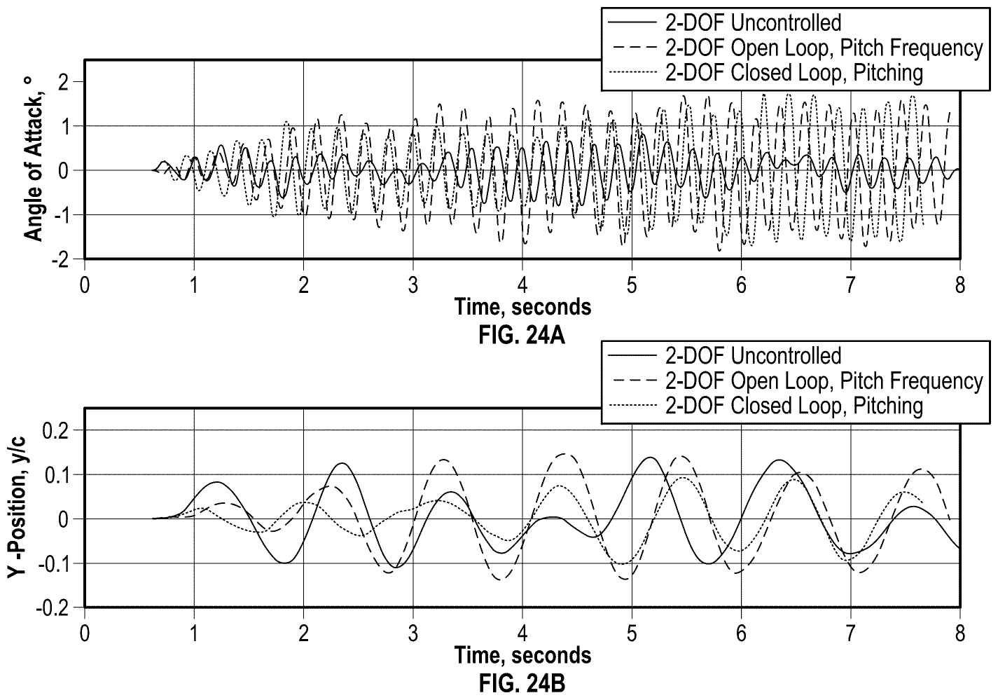

FIG. 24A and FIG. 24B show illustrative examples comprising simulated time histories of pitch and plunge for 2-DOF uncontrolled vs. open-loop and closed-loop motion of a modified Glauert airfoil configuration, in sync with pitching frequency. Both open-and closed-loop modes of SJA-based 2-DOF LCO control are shown. The open-loop control was first applied by alternating the SJA actuation on the upper and lower airfoil surfaces in synchronization with the pitching fundamental frequency identified from the uncontrolled case (4.51 Hz), so that each actuation is active for half of one cycle. By contrast, a simplified closed-loop control strategy applied to control the pitching LCO “senses” the airfoil angular velocity, and can activate an upper-surface SJA when the angular velocity is positive and the lower-surface SJA when it is negative, to ensure the control output is phase-locked to the airfoil motion. The two cases are compared to the uncontrolled case in FIG. 24A and FIG. 24B.

Both control schemes are able to increase the amplitude of the pitching motion, also resulting in some regularization of the plunging motion (especially in the open-loop case) but without any meaningful increase in the plunging amplitude. Without being bound by theory, one may conclude that for the current set of structural parameters, the pitching and plunging modes do not reveal a synergetic coupling.

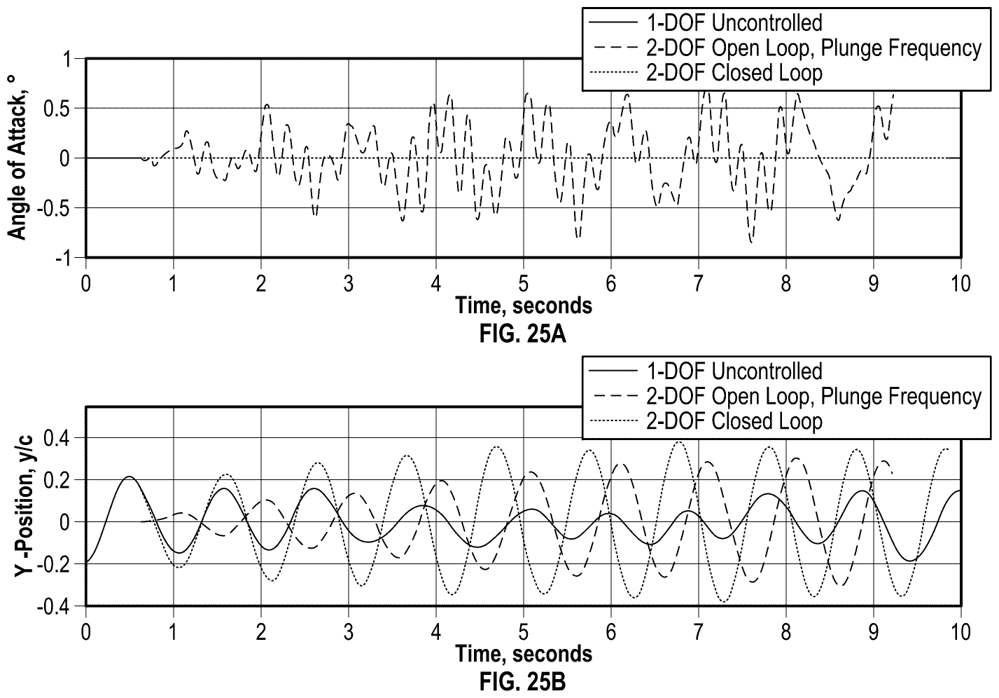

FIG. 25A and FIG. 25B show illustrative examples comprising simulated time histories of pitch and plunge for 1-DOF uncontrolled vs. 2-DOF open-loop and 1-DOF closed-loop controlled examples, in sync with plunging frequency. These open-and closed-loop control schemes are evaluated based on the natural plunging frequency (1.01 Hz) in both 2-DOF and 1-DOF plunging cases. A simplified closed-loop control strategy implements the lower-surface SJA actuation when the positive plunging motion is “sensed.” Such 1-DOF closed-loop control scheme outperformed the 1-DOF open-loop control strategy for plunging amplitude amplification. A 2-DOF open-loop control in synchronization with the plunging frequency appears to perform slightly better compared to a 2-DOF “plunging-focused” closed-loop control strategy described above. Thus, comparing the “winning” strategies with 2-DOF open-loop and 1-DOF closed-loop controls in FIG. 25A and FIG. 25B, both control schemes were successful in roughly doubling the peak amplitude of plunging (compared to the uncontrolled 1-DOF case) over the observed simulation period. It may be argued that 1-DOF plunging-only system would be beneficial in its practical implementation (from the standpoint of the system mechanical configuration) as the pitching DOF may be redundant and not producing any benefit.

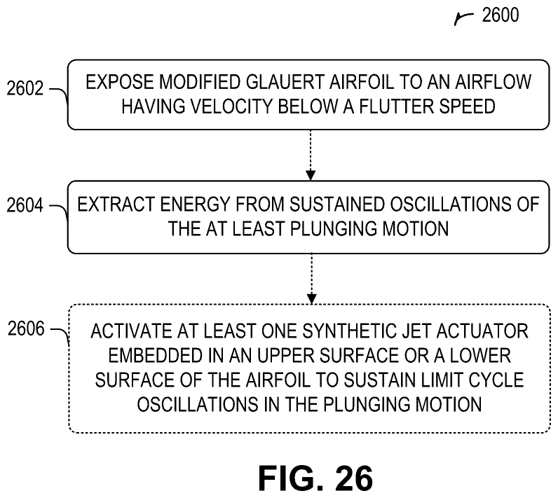

FIG. 26 illustrates generally an example of a technique, such as a machine-implemented method 2600, that can include at 2602, exposing a modified Glauert airfoil to an airflow having a velocity below a critical flutter speed, the modified Glauert airfoil located in an elastic support system enabling at least plunging motion. The method 2600 can include at 2604, extracting energy from sustained oscillations of the at least plunging motion, such as using a piezoelectric energy conversion device for converting motion of the airfoil into electrical energy. The modified Glauert airfoil can be described as a symmetric airfoil formed by mirroring an upper surface profile of a Glauert airfoil to define a lower surface profile.

Optionally at 2606, the method 2600 can include activating at least one synthetic jet actuator embedded in an upper surface or a lower surface of the airfoil to sustain limit cycle oscillations in the plunging motion. Optionally, the elastic support system enables both plunging and pitching motion, and wherein activating the at least one synthetic jet actuator controls limit cycle oscillations in degrees of freedom associated with the plunging motion and the pitching motion.

In an example, the at least one synthetic jet actuator comprises a first synthetic jet actuator embedded in the upper surface and a second synthetic jet actuator embedded in the lower surface, and at 2606, the activating the at least one synthetic jet actuator comprises alternately activating upper and lower surface actuators in synchronization with a natural plunging frequency of the airfoil, such as alternately. In an example, sustaining limit cycle oscillations comprises maintaining plunging oscillations with an amplitude of at least 0.2 chord lengths from a neutral position.

FIG. 27 illustrates a block diagram of an example comprising a machine 2700 upon which any one or more of the techniques (e.g., methodologies) discussed herein may be performed. Machine 2700 (e.g., computer system) may include a hardware processor 2702 (e.g., a central processing unit (CPU), a graphics processing unit (GPU), a hardware processor core, or any combination thereof), a main memory 2704 and a static memory 2706, connected via an interlink 2730 (e.g., link or bus), as some or all of these components may constitute hardware for systems or related implementations discussed above.

Generally, the hardware processor 2702 may, for example, include at least one of a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), a Tensor Processing Unit (TPU), a Neural Processing Unit (NPU), a Vision Processing Unit (VPU), a Machine Learning Accelerator, an Artificial Intelligence Accelerator, an Application Specific Integrated Circuit (ASIC), a Field Programmable Gate Array (FPGA), a Radio-Frequency Integrated Circuit (RFIC), a Neuromorphic Processor, a Quantum Processor, or any combination thereof. A processor circuit may further be a multi-core processor having two or more independent processors (sometimes referred to as “cores”) that may execute instructions contemporaneously. Multi-core processors contain multiple computational cores on a single integrated circuit die, each of which can independently execute program instructions in parallel. Parallel processing on multi-core processors may be implemented via architectures like superscalar, VLIW, vector processing, or SIMD that allow each core to run separate instruction streams concurrently. A processor circuit may be emulated in software, running on a physical processor, as a virtual processor or virtual circuit. The virtual processor may behave like an independent processor but is implemented in software rather than hardware.

Specific examples of main memory 2704 include Random Access Memory (RAM), and semiconductor memory devices, which may include storage locations in semiconductors such as registers. Specific examples of static memory 2706 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; or optical media such as CD-ROM and DVD-ROM disks.

The machine 2700 may further include a display device 2710, an input device 2712 (e.g., a keyboard), and a user interface (UI) navigation device 2714 (e.g., a mouse). In an example, the display device 2710, input device 2712, and UI navigation device 2714 may be a touch-screen display. The machine 2700 may include a mass storage device 2708 (e.g., drive unit), a signal generation device 2718 (e.g., a speaker), a network interface device 2720, and one or more sensors 2716, such as a global positioning system (GPS) sensor, compass, accelerometer, or some other sensor. The machine 2700 may include an output controller 2728, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The mass storage device 2708 may comprise a machine-readable medium 2722 on which is stored one or more sets of data structures or instructions 2724 (e.g., software) embodying or utilized by any one or more of the techniques or functions described herein. The instructions 2724 may also reside, completely or at least partially, within the main memory 2704, within static memory 2706, or within the hardware processor 2702 during execution thereof by the machine 2700. In an example, one or any combination of the hardware processor 2702, the main memory 2704, the static memory 2706, or the mass storage device 2708 comprises a machine readable medium.

Specific examples of machine-readable media include, one or more of non-volatile memory, such as semiconductor memory devices (e.g., EPROM or EEPROM) and flash memory devices; magnetic disks, such as internal hard disks and removable disks; magneto-optical disks; RAM; or optical media such as CD-ROM and DVD-ROM disks. While the machine-readable medium is illustrated as a single medium, the term “machine readable medium” may include a single medium or multiple media (e.g., a centralized or distributed database, or associated caches and servers) configured to store the one or more instructions 2724.

An apparatus of the machine 2700 includes one or more of a hardware processor 2702 (e.g., a central processing unit (CPU), a graphics processing unit (GPU), a hardware processor core, or any combination thereof), a main memory 2704 and a static memory 2706, sensors 2716, network interface device 2720, antennas, a display device 2710, an input device 2712, a UI navigation device 2714, a mass storage device 2708, instructions 2724, a signal generation device 2718, or an output controller 2728. The apparatus may be configured to perform one or more of the methods or operations disclosed herein.

The term “machine readable medium” includes, for example, any medium that is capable of storing, encoding, or carrying instructions for execution by the machine 2700 and that cause the machine 2700 to perform any one or more of the techniques of the present disclosure or causes another apparatus or system to perform any one or more of the techniques, or that is capable of storing, encoding or carrying data structures used by or associated with such instructions. Non-limiting machine-readable medium examples include solid-state memories, optical media, or magnetic media. Specific examples of machine-readable media include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); or optical media such as CD-ROM and DVD-ROM disks. In some examples, machine readable media includes non-transitory machine-readable media. In some examples, machine readable media includes machine readable media that is not a transitory propagating signal.

The instructions 2724 may be transmitted or received, for example, over a communications network 2726 using a transmission medium via the network interface device 2720 utilizing any one of a number of transfer protocols (e.g., frame relay, internet protocol (IP), transmission control protocol (TCP), user datagram protocol (UDP), hypertext transfer protocol (HTTP), etc.). Example communication networks include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®), IEEE 802.15.4 family of standards, a Long Term Evolution (LTE) 4G or 5G family of standards, a Universal Mobile Telecommunications System (UMTS) family of standards, peer-to-peer (P2P) networks, satellite communication networks, among others.

In an example, the network interface device 2720 includes one or more physical jacks (e.g., Ethernet, coaxial, or other interconnection) or one or more antennas to access the communications network 2726. In an example, the network interface device 2720 includes one or more antennas to wirelessly communicate using at least one of single-input multiple-output (SIMO), multiple-input multiple-output (MIMO), or multiple-input single-output (MISO) techniques. In some examples, the network interface device 2720 wirelessly communicates using Multiple User MIMO techniques. The term “transmission medium” shall be taken to include any intangible medium that is capable of storing, encoding or carrying instructions for execution by the machine 2700, and includes digital or analog communications signals or other intangible medium to facilitate communication of such software.

### Various Notes

Each of the non-limiting aspects above can stand on its own or can be combined in various permutations or combinations with one or more of the other aspects or other subject matter described in this document.

The above detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc., are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Such instructions can be read and executed by one or more processors to enable performance of operations comprising a method, for example. The instructions are in any suitable form, such as but not limited to source code, compiled code, interpreted code, executable code, static code, dynamic code, and the like. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A wind energy harvesting system comprising:
an airfoil structure defining an upper surface and a lower surface;
at least one synthetic jet actuator located in at least one of the upper surface or lower surface;
an elastic mounting system supporting the airfoil structure and enabling at least plunging motion of the airfoil structure; and
a controller configured to activate the at least one synthetic jet actuator to sustain cyclic oscillation of the airfoil structure in a plunging degree of freedom.

2. The system of claim 1, wherein the airfoil structure comprises a Glauert airfoil configuration having a natural flow separation region.

3. The system of claim 2, wherein the at least one synthetic jet actuator is located in a range of 67% to 68% chord from a leading edge of the airfoil structure.

4. The system of claim 1, wherein:
the elastic mounting system enables both the plunging motion and pitching motion of the airfoil structure; and
the controller is configured to activate the at least one synthetic jet actuator to sustain limit cycle oscillations in both plunging and pitching degrees of freedom.

5. The system of claim 1, wherein the at least one synthetic jet actuator comprises:
a first synthetic jet actuator embedded in the upper surface; and
a second synthetic jet actuator embedded in the lower surface.

6. The system of claim 5, wherein the controller is configured to activate the first and second synthetic jet actuators respectively in synchronization with a natural plunging frequency of the airfoil structure.

7. The system of claim 1, further comprising a piezoelectric energy conversion structure mechanically coupled to the airfoil structure and configured to extract energy from the plunging motion.

8. An airfoil apparatus comprising:
an airfoil body having an upper surface and a lower surface, the upper surface and the lower surface comprising Glauert airfoil profiles;
a first synthetic jet actuator embedded in the upper surface; and
a second synthetic jet actuator embedded in the lower surface.

9. The apparatus of claim 8, wherein the first and second synthetic jet actuators are configured to actively modify flow attachment characteristics of the airfoil body in response to a controller.

10. The apparatus of claim 8, wherein the airfoil body comprises a symmetric airfoil formed by mirroring an upper surface profile of a Glauert airfoil to define a lower surface profile.

11. The apparatus of claim 10, wherein the airfoil body is configured to exhibit natural flow separation at about 64% chord from a leading edge of the airfoil; and
wherein the synthetic jet actuators are located in a range of 67% to 68% chord from the leading edge of the airfoil.

12. The apparatus of claim 8, wherein the first and second synthetic jet actuators are configured to operate at a frequency of approximately 200 Hertz (Hz).

13. The apparatus of claim 8, wherein the airfoil body is configured to sustain limit cycle oscillations at flow velocities below a critical flutter speed without requiring activation of the first and second synthetic jet actuators.

14. A method of harvesting wind energy comprising:
exposing a modified Glauert airfoil to an airflow having a velocity below a critical flutter speed, the modified Glauert airfoil located in an elastic support system enabling at least plunging motion; and
extracting energy from sustained oscillations of the at least plunging motion;
wherein modified Glauert airfoil body comprises a symmetric airfoil formed by mirroring an upper surface profile of a Glauert airfoil to define a lower surface profile.

15. The method of claim 14, comprising activating at least one synthetic jet actuator embedded in an upper surface or a lower surface of the airfoil to sustain limit cycle oscillations in the plunging motion.

16. The method of claim 15, wherein the elastic support system enables both plunging and pitching motion, and wherein activating the at least one synthetic jet actuator controls limit cycle oscillations in degrees of freedom associated with the plunging motion and the pitching motion.

17. The method of claim 15, wherein the at least one synthetic jet actuator comprises:
a first synthetic jet actuator embedded in the upper surface; and
a second synthetic jet actuator embedded in the lower surface; and
wherein the activating the at least one synthetic jet actuator comprises alternately activating upper and lower surface actuators in synchronization with a natural plunging frequency of the airfoil.

18. The method of claim 17, wherein the airfoil is configured to exhibit natural flow separation at about 64% chord from a leading edge of the airfoil; and
wherein the synthetic jet actuators are located in a range of 67% to 68% chord from the leading edge of the airfoil.

19. The method of claim 14, wherein sustaining limit cycle oscillations comprises maintaining plunging oscillations with an amplitude of at least 0.2 chord lengths from a neutral position.

20. The method of claim 14, wherein extracting energy comprises converting mechanical energy from the plunging oscillations to electrical energy using a piezoelectric device.
